(19) United States
(12) Patent Application Publication
(10) Pub. No.: US 2020/0218940 A1
(43) Pub. Date: Jul. 9, 2020

(54) CREATING AND MANAGING MACHINE LEARNING MODELS IN A SHARED NETWORK ENVIRONMENT

(71) Applicant: INTERNATIONAL BUSINESS MACHINES CORPORATION, ARMONK, NY (US)

(72) Inventors: HOWARD N. ANGLIN, LEANDER, TX (US); FANG WANG, WESTFORD, MA (US); SU LIU, AUSTIN, TX (US); ANNA CHANEY, WILLIAMSON, TX (US)

(21) Appl. No.: 16/242,425

(22) Filed: Jan. 8, 2019

(51) Int. Cl. G06K 9/62; G06N 20/00; H04L 9/06; H04L 29/06; G06F 21/64

(52) U.S. Cl. CPC G06K 9/6257; G06N 20/00; G06F 21/64; H04L 65/4023; H04L 9/0637

(57) ABSTRACT

A distributed system includes a model engine coupled to a data source storing training data and to a data source storing testing data. The model engine is being operated in accordance with a smart contract to enable entities to collaboratively produce a model based on the training data using blockchain infrastructure. Contributions of each entity are entered into a ledger of the blockchain as blocks. The model engine is configured to provide a model that utilizes the data based on criteria specified by an entity and configured to track and post changes to the model or data to a ledger of the blockchain according to the smart contract and configured to generate encrypted keys to enable the entities to exchange the tracked changes to the model or data and to exchange an updated model.

### BACKGROUND

The present invention relates to collaborative machine learning and, more specifically, to collaborative creation and management of machine learning models in which several distinct parties collaborate to train and generate a variety of machine learning models.

Machine learning is a process to analyze data in which the dataset is used to determine a model (also called a rule or a function) that maps input data (also called explanatory variables or predictors) to output data (also called dependent variables or response variables). One type of machine learning is supervised learning in which a model is trained with a dataset including known output data for a sufficient number of input data. Once a model is trained, it may be deployed, i.e., applied to new input data to predict the expected output.

Machine learning may be applied to regression problems (where the output data are numeric, e.g., a voltage, a pressure, a number of cycles) and to classification problems (where the output data are labels, classes, and/or categories, e.g., pass-fail, failure type, etc.). For both types of problems, a broad array of machine learning algorithms is available, with new algorithms the subject of active research. For example, artificial neural networks, learned decision trees, and support vector machines are different classes of algorithms which may be applied to classification problems. And, each of these examples may be tailored by choosing specific parameters such as learning rate (for artificial neural networks), number of trees (for ensembles of learned decision trees), and kernel type (for support vector machines).

The large number of machine learning options available to address a problem makes it difficult to choose the best option or even a well-performing option. The amount, type, and quality of data affect the accuracy and stability of training and the resultant trained models. Further, problem-specific considerations, such as tolerance of errors (e.g., false positives, false negatives) scalability, and execution speed, limit the acceptable choices. Therefore, there exists a need for a secure and robust approach to identify and to engage the appropriate dataset and related algorithms to satisfy the conditions for a particular machine learning model of interest.

### SUMMARY

Embodiments of the present invention are directed to a distributed machine learning system. A non-limiting example of the distributed machine learning system includes a memory having computer-readable instructions and one or more processors for executing a model engine communicatively coupled to at least one data source storing training data and to at least one data source storing testing data. The model engine is being operated in accordance with a smart contract to enable two or more entities to collaboratively produce a machine learning model based on the training data using blockchain infrastructure. Contributions of each of the two or more entities are entered into a ledger of the blockchain infrastructure as blocks. The model engine is configured to execute the computer-readable instructions. The instructions include providing a machine learning model that utilizes the training data and testing data based on criteria specified by an entity and tracking changes to the machine learning model, training data or testing data made by the entities. The instructions further include posting changes to the machine learning model, training data or testing data to the ledger of the blockchain infrastructure according to terms and specifications of the smart contract and generating encrypted keys to enable the entities to utilize the blockchain infrastructure to exchange the tracked changes to the machine learning model, training data or testing data and to exchange an updated machine learning model.

Embodiments of the present invention are directed to a method for enabling two or more entities to collaboratively produce a machine learning model based on training data using blockchain infrastructure in a distributed machine learning system. A non-limiting example of the method includes providing a machine learning model that utilizes the training data and testing data based on criteria specified by two or more entities. Changes to the machine learning model, training data or testing data made by at least one of the two or more entities are tracked and posted to a ledger of the blockchain infrastructure according to terms and specifications of a smart contract. The smart contract enables two or more entities to collaboratively produce the machine learning model based on the training data using the blockchain infrastructure. Contributions of each of the two or more entities are entered into the ledger of the blockchain infrastructure as blocks. Encrypted keys are generated to enable the two or more entities to utilize the blockchain infrastructure to exchange the tracked changes to the machine learning model, training data or testing data and to exchange an updated machine learning model.

Embodiments of the invention are directed to a computer-program product for enabling two or more entities to collaboratively produce a machine learning model based on training data using blockchain infrastructure in a distributed machine learning system, the computer-program product including a computer-readable storage medium having program instructions embodied therewith. The program instructions are executable by a processor to cause the processor to perform a method. A non-limiting example of the method includes providing a machine learning model that utilizes the training data and testing data based on criteria specified by two or more entities. Changes to the machine learning model, training data or testing data made by at least one of the two or more entities are tracked and posted to a ledger of the blockchain infrastructure according to terms and specifications of a smart contract. The smart contract enables two or more entities to collaboratively produce the machine learning model based on the training data using the blockchain infrastructure. Contributions of each of the two or more entities are entered into the ledger of the blockchain infrastructure as blocks. Encrypted keys are generated to enable the two or more entities to utilize the blockchain infrastructure to exchange the tracked changes to the machine learning model, training data or testing data and to exchange an updated machine learning model.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a conventional method of training a machine-learning based model;

FIG. 2 depicts a schematic diagram of one illustrative embodiment of a distributed machine learning system in a computer network;

FIG. 3 is a flow diagram of a blockchain transaction configuration according to example embodiments;

FIG. 4 illustrates a block diagram of an example blockchain network, in accordance with example embodiments;

FIG. 5 illustrates a workflow for posting changes to various models as well as changes to training data and testing data to a ledger of the blockchain infrastructure in accordance with an embodiment of the invention;

FIG. 6 is a flow diagram of a method for collaboratively producing a machine learning model by two or more entities based on the training data and testing data using blockchain infrastructure, according to some embodiments of the invention; and

FIG. 7 is a block diagram of a computer system for implementing some or all aspects of the distributed machine learning system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, the methods, and systems described below may advantageously be employed by various artificial intelligence systems that are tasked to provide machine learning models. The focus of the technology described herein is to help enterprises, academics, and consumers that might be struggling to capture the value of artificial intelligence through machine learning processes. In general, it is advantageous to enable distinct parties to collaboratively participate in training a variety of machine learning models (without exposing training datasets). This results in all parties benefitting from more robust machine learning models. However, there are subtle variations when designing different types of machine learning models. Even the simplest use case for a machine learning model may require quite unique training datasets.

Turning now to an overview of the aspects of the invention, one or more embodiments of the invention address the above-described shortcomings of the prior art by providing a framework that enables the creation of many unique machine learning models in an efficient manner. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown. According to various embodiments of the present invention, intelligent automated distributed machine learning system provides a blockchain based model engine component that is configured, designed and/or operable to identify and engage various types of datasets and related algorithms to satisfy the conditions for a machine learning model for a task at hand. Currently, data needed to train machine learning models with sufficient variety and relevance (e.g., image data from the captured images that can be used to train the model to detect a face of a person in the image) typically resides in silos. At least some types of data (e.g., steganographic data) may be difficult to access for data scientists outside of a given organization. Advantageously, embodiments of the present invention provide a mechanism to utilize external data, when training a machine learning model (such as a deep learning model), so that a model may be trained based on a plurality of classifiers and sets of training data and/or testing data. Thus, embodiments of the intelligent distributed machine learning system employ a process for using and sharing fast learning models by a plurality of entities.

The above-described aspects of the invention address the shortcomings of the prior art by providing efficient machine learning model marketplace described in greater detail below. In the past, there has not been an efficient inventive model lifecycle in the context of agreements across multiple entities that may have ownership stake in a model. With embodiments of the invention, however, distributed machine learning system can be more efficiently trained by having access to a variety of training/testing data.

As an overview, a blockchain is a distributed database that maintains a continuously growing list of data records, which have been hardened against tampering and revision. The blockchain consists of data structure blocks, which exclusively hold data in initial blockchain implementations, and both data and programs in some of the more recent implementations. Each block in the blockchain holds batches of individual transactions and the results of any blockchain executables. Each block contains a timestamp and information linking it to a previous block in the blockchain.

The blockchain is considered to be the main technical innovation of bitcoin, where the blockchain serves as the public ledger of all bitcoin transactions. Bitcoin is peer-to-peer (P2P); every user is allowed to connect to the network, send new transactions to the blockchain; verify transactions, and create new blocks. For this reason, the blockchain is described to be permissionless.

Although in the embodiments of the present invention, blockchain is not being used for currency transactions, it is useful to note that, in the context of its first digital currency, bitcoin, a blockchain is a digital ledger recording every bitcoin transaction that has ever occurred. The digital ledger is protected by powerful cryptography typically considered to be impossible to break. More importantly, though, the blockchain resides not in a single server, but across a distributed network of computers. Accordingly, whenever new transactions occur, the blockchain is authenticated across this distributed network, and then the transaction is included as a new block on the chain.

Transactions are the content stored in the blockchain and are created by participants using the system. Although, as stated above, blockchain is not being used for currency transactions, it is useful to note that, in the case of cryptocurrencies, a transaction is created whenever a cryptocurrency owner sends cryptocurrency to someone else. In this regard, a cryptocurrency should be understood to be a medium of exchange using cryptography to secure the transactions and to control the creation of additional units of the currency. System users create transactions that are passed from node to node, that is, computer to computer, on a best-effort basis. The system implementing the blockchain defines a valid transaction. In cryptocurrency applications, a valid transaction must be digitally signed, and must spend one or more unspent outputs of previous transactions; the sum of transaction outputs must not exceed the sum of transaction inputs.

Blocks record and confirm when and in what sequence transactions enter and are logged into the blockchain. Blocks are created by users known as “miners”, who use specialized software or equipment designed specifically to create blocks. In a cryptocurrency system, miners are incentivized to create blocks to collect two types of rewards: a pre-defined per-block award, and fees offered within the transactions themselves, payable to any miner who successfully confirms the transaction.

Every node in a decentralized system has a copy of the blockchain. This avoids the need to have a centralized database managed by a trusted third party. Transactions are broadcast to the network using software applications. Network nodes can validate transactions, add them to their copy, and then broadcast these additions to other nodes. To avoid the need for a trusted third party to timestamp transactions, decentralized blockchains use various timestamping schemes, such as proof-of-work.

The advantages of blockchain for bitcoin include:
(1) The ability for independent nodes to converge on a consensus of the latest version of a large data set such as a ledger, even when the nodes are run anonymously, have poor interconnectivity, and have operators who are dishonest or malicious;
(2) The ability for any well-connected node to determine, with reasonable certainty, whether a transaction does or does not exist in the data set;
(3) The ability for any node that creates a transaction to determine, after a confirmation period, with a reasonable level of certainty, whether the transaction is valid, is able to take place, and become final, that is to say, that no conflicting transactions were confirmed into the blockchain elsewhere that would invalidate the transaction, such as the same currency units “double-spent” somewhere else;
(4) A prohibitively high cost to attempt to rewrite or alter transaction history;
(5) Automated conflict resolution that ensures that conflicting transactions, such as two or more attempts to spend the same balance in different places, never become part of the confirmed data set.

As noted above, it is desirable for entities contributing data to train an evolving machine learning model to do so in collaboration with many other entities. As such, there is no mechanism in place to facilitate model/data/algorithm sharing. Currently, there is no single fair way to measure or to determine the contribution of different entities to such learning models. In accordance with embodiments of present invention, blockchain provides a useful means for tracking and storing the contributions of various model producing participants. It is also useful for dispute resolution. This is because no single entity has complete control of model and data.

One of the goals of embodiments of the present invention is “credit assignment and reward.” Blockchain is particularly useful when machine learning model training is done in a shared space, is non-centralized, and when “bounties” are offered for certain contributions. Trust, or the lack thereof, which is a significant issue in machine learning model sharing, can therefore be addressed.

There has long been a need for a secure and robust approach to provide access to data that may be used to train and test a variety of machine learning models for the purpose of credit, reward, and dispute resolution, and for other purposes. Embodiments of the present invention meet this need and may also implement a common smart contract to determine that all stakeholders, that is, organizations, competitors, data vendors, universities, data scientists, and the like, are meeting their agreements about corresponding machine learning models. Machine learning algorithms that make up each model, training/testing data and modifications associated with a stakeholder are compiled into a chain of model transaction blockchain blocks. The chain can be considered a chronicle of a particular machine learning model, such as a growing piece of complex data needed to efficiently train the model, the model “status”. Furthermore, model's complete history can be tracked, including various versions of the model, various users, various model parameters, etc. Once the new block has been calculated, it can be appended to the stakeholder's machine learning model history blockchain, as described above. The block may be updated in response to many triggers, such as, but not limited to, when a user requests machine learning model service, when new data has been provided to a training dataset, when new data has been provided to a testing dataset, when a training of the model is complete, and so forth.

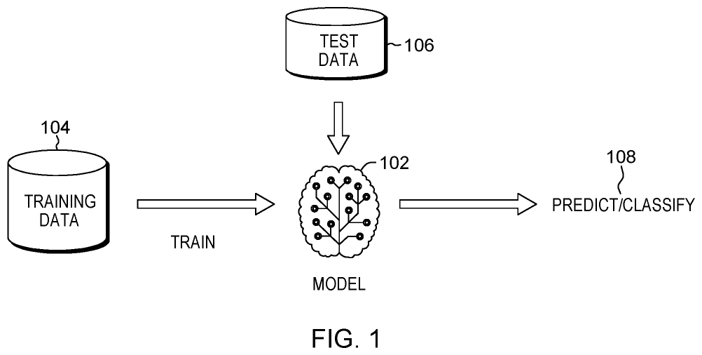

FIG. 1 illustrates a conventional method of training a machine-learning based model. A machine learning model 102 is capable of learning from data. As noted above, machine learning model 102 can include a trainable machine learning algorithm that can be trained to learn functional relationships between inputs and outputs that are currently unknown.

FIG. 1 further illustrates data sources. A plurality of data sources may include data that is collected and/or ingested for processing by a machine learning model 102. More specifically data sources may include training data 104 and test data 106. By processing training data 104 and test data 106, machine learning model 102 may generate data objects representing predicted/classified output data 108.

However, typically each organization developing a model has its own private training data 104 and test data 106. Given the nature of various machine learning systems and the requirements that each entity must keep its private data secured, a researcher developing a model is hard pressed to gain access to the large quantities of high quality training data 104 necessary to build desirable trained machine learning models 102. More specifically, the researcher would have to gain authorization from each entity having private data that is of interest. Further, due to various restrictions (e.g., privacy policies, regulations, HIPAA compliance, etc.), each entity might not be permitted to provide requested data to the researcher. Even under the assumption that the researcher is able to obtain permission from all of entities to obtain their relevant private training data 104/test data 106, entities would still have to de-identify the datasets. Such de-identification can be problematic due to the time required to de-identify the data and due to loss of information, which can impact the researcher's ability to gain knowledge from training machine learning models.

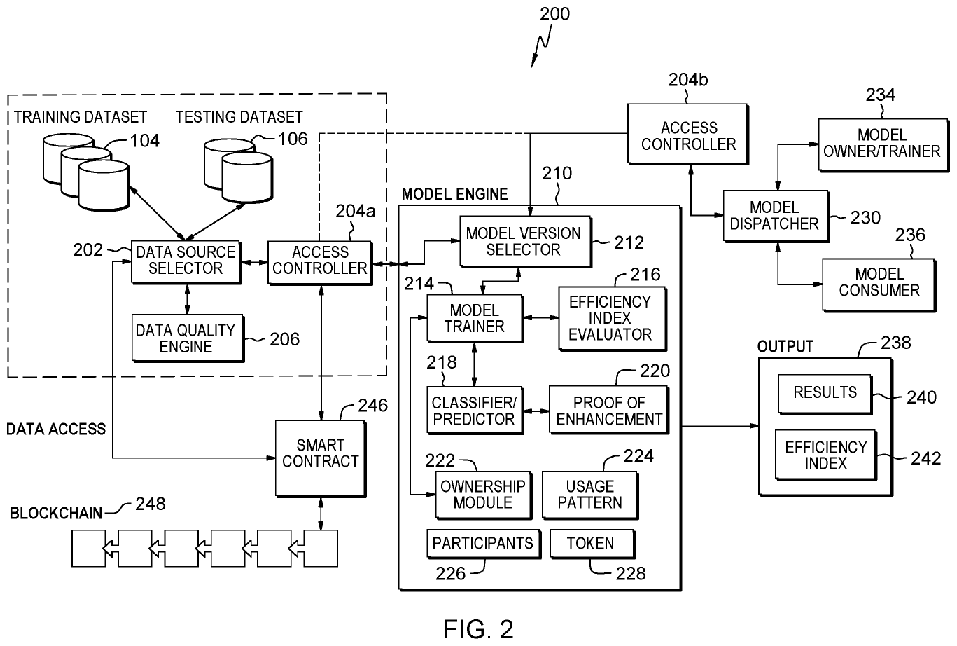

FIG. 2 depicts a schematic diagram of one illustrative embodiment of a distributed machine learning system 200 in a computer network. In one embodiment, system 200 may be configured as a computer-based research tool allowing multiple model owners/trainers 234 (e.g., researchers or data analysts) to create trained machine learning models from many private or secured data sources (e.g., training datasets 104), to which the model owners 234 and/or model consumers 236 (e.g., researchers) would not normally have permission or authority to access. In the example shown, access controller 204b determines if model owner 234 and/or model consumer 236 has permission to access a computing device executing as a global model engine 210.

In various embodiments, one or more distributed model engines 210 may be configured to manage many modeling tasks. Thus, the number of active models could number in the hundreds, thousands, or even more than one million models. Therefore, the inventive subject matter is also considered to include management apparatus or methods of the large number of model objects in the distributed system. For example, each modeling task can be assigned one or more identifiers, or other metadata, for management by the system. More specifically, identifiers can include a unique model identifier, a task identifier that is shared among models belonging to the same task, a model owner identifier, time stamps, version numbers, an entity or private data server identifier, geostamps, or other types of identifiers (IDs). Further, the global model engine 210 can be configured to present a dashboard to a model consumer 236 that compiles and presents the status of each project. The dashboard can be configured to drill down to specific models and their current state (e.g., NULL, instantiated, training, trained, updated, deleted, etc.).

In one non-limiting example, market researchers, product promoters, marketing employees, agents, and/or other people and/or organizations chartered with the responsibility of product management typically attempt to justify marketing decisions based on one or more techniques likely to result in increased sales of a product of interest. Often, sales forecasting is an important step in the evaluation of potential product initiatives, and a key qualification factor for the decision to launch in-market. As such, accurate forecasting models are important to facilitate these decisions. One specific type of initiative that adds an extra layer of complexity compared to a new product or line extension is a restage initiative. A restage initiative replaces an existing product or group of products with a modified form of the product. Examples of modifications include, but are not limited to new product formulation(s), new packaging, new sales messaging, etc. Simulating restage initiatives typically requires modeling both the consumer response to the intrinsic product change, and the rate at which consumers become aware and digest the change that has occurred to the product. In one embodiment, model consumer 236 may be interested to access a restage initiative model.

Model consumer 236 or model owner 234 may send model accessing request to a model dispatcher 230. The model accessing request may include at least one of: a unique model identifier, a task identifier that is shared among models belonging to the same task, a model owner identifier, a model consumer identifier and/or other criteria associated with a model of interest. Generally, model dispatcher 230 may be configured to receive a request and dispatch the request to the appropriate model engine 210 via access controller 204b. As noted above, access controller 204b determines if model owner 234 and/or model consumer 236 has permission to access a particular model engine 210, particular model or a particular dataset. Thus, upon receiving a request, access controller 204b can forward the request to model engine 210. Model engine 210 can receive the request and based on the received model criteria determine if such model exists. If the model exists, model version selector 212 may locate the appropriate model (e.g., based on corresponding identifiers, such as, for example, model identifier or task identifier). If model satisfying the required criteria does not exist, model version selector 212 may generate a new model based on specified criteria. Model engine 210 may return a model ID identifying the appropriate type of model back to model dispatcher 230. Model dispatcher 230 may then use the model ID to dispatch the model and render the model to the model owner 234 and/or model consumer 236 via the dashboard, for example.

In some embodiments, model owner/trainer 234 may be interested to generate new data. Once model version selector 212 identifies a particular model of interest, it may determine if model owner 234 has permission to access a particular dataset in one or more data sources by sending another request to access controller 204a configured to control data access. As new training data is generated and relayed to model engine 210, the model engine 210 aggregates the data and generates an updated model. Once the model is updated, it can be determined whether the updated model is an improvement over the previous version of the same model that was located by model version selector 212. If the updated model is an improvement (e.g., the predictive accuracy is improved), new model parameters may be provided to the blockchain ledger 248, described in greater detail below, via updated model transaction (instructions), for example. In one embodiment, the performance of the trained model (e.g., whether the model improves or worsens) can be evaluated using efficiency index evaluator 216 to determine whether the new data generated by model owner/trainer 234 results in an improved trained model. Parameters associated with various machine learning model versions may be stored by model version selector in blockchain ledger 248, as described below, so that earlier machine learning models may be later retrieved, if needed.

In one embodiment, model engine 210 may utilize one or more weights to be used to determine a weighted accuracy for a set of models that have been trained with the training data. In further embodiments, the weights can be used to tune the models as they are being trained. A model trainer 234 can train different types of predictive models using the training data stored in the training data source 104. In some embodiments, the selected machine learning technique (algorithm) may be controlled by classifier/predictor 218. Model efficiency index evaluator 216 calculates a weighted accuracy for each of the predictive models using the weights.

Classifier/predictor 218 may employ quite many different types of machine learning algorithms including implementations of a classification algorithm, a neural network algorithm, a regression algorithm, a decision tree algorithm, a clustering algorithm, a genetic algorithm, a supervised learning algorithm, a semi-supervised learning algorithm, an unsupervised learning algorithm, a deep learning algorithm, or other types of algorithms. More specifically, machine learning algorithms can include implementations of one or more of the following algorithms: a support vector machine, a decision tree, a nearest neighbor algorithm, a random forest, a ridge regression, a Lasso algorithm, a k-means clustering algorithm, a boosting algorithm, a spectral clustering algorithm, a mean shift clustering algorithm, a non-negative matrix factorization algorithm, an elastic net algorithm, a Bayesian classifier algorithm, a RANSAC algorithm, an orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3 (ID3), C4.5 and C5.0, chi-squared automatic interaction detection (CHAID), decision stump, M5, conditional decision trees, least-angle regression (LARS), naive bayes, gaussian naive bayes, multinomial naive bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented. Training may be supervised, semi-supervised, or unsupervised. In some embodiments, the machine learning systems may use Natural Language Processing (NPL) to analyze data (e.g., audio data, text data, etc.). Once trained, the trained model of interest represents what has been learned or rather the knowledge gained from training data 104 as desired by the model owner/trainer 234 submitting the machine learning job. The trained model can be considered a passive model or an active model. A passive model represents the final, completed model on which no further work is performed. An active model represents a model that is dynamic and can be updated based on various circumstances. In some embodiments, the trained model is updated in real-time, on a daily, weekly, bimonthly, monthly, quarterly, or annual basis. As new information is made available (e.g., shifts in time, new or corrected training data 104, etc.), an active model will be further updated. In such cases, the active model carries metadata that describes the state of the model with respect to its updates. The metadata can include attributes describing one or more of the following: a version number, date updated, amount of new data used for the update, shifts in model parameters, convergence requirements, or other information. Such information provides for managing large collections of models over time, where each active model can be treated as a distinct manageable object. The metadata associated with each model may also be stored in blockchain ledger 248.

In some embodiments, model engine 210 may be configured to provide proof of enhancement 220. If there are multiple model trainers 234 contributing to the same trained model, proof of enhancement is a way to indicate which entity/participant 226 provided more value to the model by enhancing it (e.g., by enhancing training data 104).

Yet another possible area where the disclosed inventive subject matter would be useful includes learning from private image collections. Consider an example where there are multiple, distributed data sources of private images; on many person's individual home computers, for example. The disclosed techniques would allow model trainers 234 to study information within the private image collections without requiring access to the specific images. Such a feat can be achieved by, assuming the owner's permission is granted via smart contract 246, installing model engine 210 on each person's computer. The model engine 210 can receive local training data 104 in the form of original images along with other training information (e.g., annotations, classifications, scene descriptions, locations, time, settings, camera orientations, etc.). Model engine 210 can then create local trained models from the original images and training information. Testing data 106 can be generated by constructing similar images, possibly based on eigenvectors of the trained model.

In some embodiments, for unsupervised learning, training dataset 104 is fed into model engine 210, and the model engine 210 analyses the data based upon clustering of data points. In this type of analysis, the underlying structure or distribution of the data is used to generate a model reflecting the distribution or structure of the data. This type of analysis is frequently used to detect similarities (e.g., are two images the same), identify anomalies/outliers, or to detect patterns in a set of data. Model engine 210 may further keep track of data usage patterns 224 by various participants 226.

Optionally, upon the generation of a new model, model engine 210 may assign a single token 228 to the model; the token 228 may also be provided to one or more model owners 234. Any transaction related to the model may include the “single token” 228 of the model. For example, a query for fetching the details of all or part of a model may pass the “single token” and a public key. Any authorized entity connected to model engine 210 may verify the identity of that model as long as they present the token 228 as part of the transaction.

When multiple participants 226 (which may include multiple model owners/trainers 234) contribute to the creation/training of a particular model, an ownership module 222 of the model engine 210 may determine ownership of the model based on contribution of all participants 226.

As noted above, model engine 210 may be configured as a computer-based research tool allowing multiple model owners/trainers 234 to create trained machine learning models from many private or secured training data sources 104 and/or testing data sources 106 by communicating with data access controller 204a and data source selector 202. Testing dataset 106 is a dataset used by model engine 210 to evaluate performance of one or more machine learning models. The data source selector 202 determines the data sources 104, 106 impacted, the data to be requested from the data sources 104, 106, and potential ways of requesting the data from the data sources 104, 106. Data source selector 202 may map table names and column identifiers to models that are associated with some or all of the data to be requested.

According to embodiments of the present invention, a trained model can include metadata, as discussed previously, that describes the nature of the trained model. Furthermore, the trained model comprises several parameters. Model parameters are the specific values that are used by the trained model for prediction purposes when operating on live data. Thus, model parameters can be considered an abstract representation of the knowledge gained from creating the trained model from training data 104. Advantageously, when model metadata and model parameters are packaged and stored using shared blockchain ledger 248, other model engines 210 having access to shared blockchain ledger 248 can accurately reconstruct a particular instance of the model via instantiating a new instance of the model, from the parameters stored by the blockchain ledger 248, locally at the remote computing device without requiring access to training dataset 104, thus eliminating the need for de-identification. Model parameters depend on the nature of the trained model and its underlying implementation of machine learning algorithm as well as the quality of the training data 104 used to generate that particular model. Examples of model parameters include, but are not limited to, weights, kernels, layers, number of nodes, sensitivities, accuracies, accuracy gains, hyper-parameters, or other information that can be leveraged to re-instantiate a trained machine learning model. In some embodiments, data source selector 202 may communicate with a data quality engine 206 to determine quality of the training data 104 before providing appropriate data to the model engine 210.

The blockchain ledger 248 enables automated execution of various transactions related to various machine learning models with verified determinism of smart contract 246 execution. Generally, it does not matter where smart contract 246 is deployed and how many instances of a smart contract 246 are deployed in a distributed system, because the latter is just a normal redundancy and availability concern instead of a blockchain or smart contract specific concern. As noted above, smart contract 246 governs functionality of one or more model engines 210 and facilitates a shared machine learning model infrastructure where data sovereignty is maintained and protected when training a variety of machine learning models. Functionality of the blockchain ledger 248 will be described in greater detail below.

So long as a smart-contract 246 is deterministic, it can be deployed selective on-chain, off-chain remotely, or hybrid deployment. Here “selective on-chain” means all instances of smart contract 246 are deployed on all or some blockchain validating nodes, “off-chain remotely” means all instances of smart contract 246 are deployed outside of the blockchain ledger 248 (i.e., not on any blockchain validating nodes), “hybrid deployment” means that some instances of smart contract 246 are deployed on some validating nodes of the blockchain ledger 248 (selective on-chain) while other instances of the same smart-contract 246 are deployed remotely outside of the blockchain ledger 248.

At least in some embodiments, model engine 210 may be configured to provide some kind of output 238. In one embodiment, output 238 may include results 240 provided by the model requested by model owner 234 and/or model consumer 236. Output may further include model efficiency index 242 calculated by the efficiency index evaluator 216. In an embodiment, model's efficiency index 242 may be measured by usage pattern metrics 224 of specific features and by accuracy of the evaluated model. For example, consider an image recognition model that is applied to identify possible images of cats. The participant (e.g., model trainer 234) that provided the most efficient cat identifying feature to such model would be weighted higher for compensation purposes, for example.

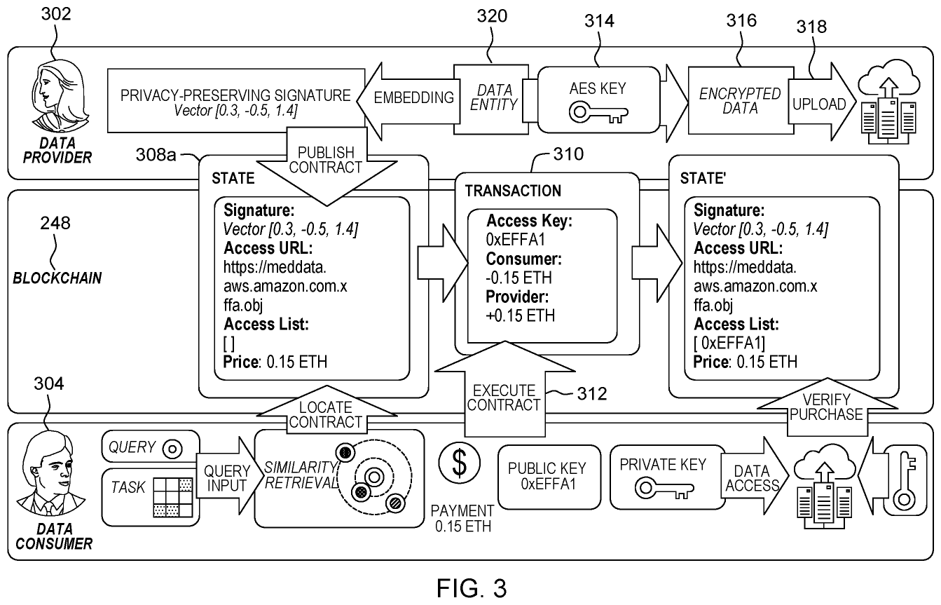

FIG. 3 is a flow diagram of a blockchain transaction configuration according to example embodiments. The diagram in FIG. 3 illustrates the blockchain ledger 248 implemented in a context of distributed data vending framework. In this illustrative embodiment, a data provider 302 is an entity who owns training data 104 and/or testing data 106 and can potentially sell the data access on blockchain ledger 248.

When a data provider wants to sell a piece of training or testing data, the raw data is firstly formatted into a data entity 320 and data is then embedded into a privacy preserving signature vector. After that, referring now to FIGS. 2 and 3, access controller 204a, associated with the corresponding data source, generates an Advanced Encryption Standard (AES) key 314 and provides 318 the data encrypted 316 by the AES key 314 to data source selector 202. Data provider 302 then creates smart contract 246 in the blockchain ledger 248 as described above.

A data request/purchase from any data consumer 304 (e.g., model consumer 236) via model engine 210 triggers a decryption process where the access controller 204a sends the AES key 314 to a data requesting model engine 210 via a secure channel after handshaking.

In one embodiment, data source selector 202 hosts links to the encrypted training and/or testing data entities from data providers 302. Whenever a data access request is initiated by access controller 204a on a certain data entity, the access controller 204a first retrieves its associated smart contract 246 in blockchain ledger 248. In an embodiment, data access rights to a particular dataset of the training data or testing data is determined by a predefined agreement specified by the smart contract. When the smart contract is executed 312 and data consumer 304 is authenticated by its public key in the smart contract 246, the encrypted data can be provided to the data consumer 304.

The blockchain ledger 248 can be any chain that enables smart contracts, such as Ethereum, VeChain, and the like. Whenever data provider 302 lists a data entity for sale, smart contract 246 is created that includes, for example, the data signature, an access URL of the AWS server) or an API address for retrieval, a list of public keys that granted data access, as well as the selling price for the data access. Smart contract 246 can also include many more details such as information related to creation of a new model, model properties, information identifying all owners and/or all consumers of the model, information related to data sources used to create the model, among many others

Once the transaction 310 is confirmed in the blockchain ledger 248, access controller 204a authenticates the data consumer 30 using consumer's private key information and provides encrypted data of interest to model engine 210. The data download begins once the payment is verified by the server and the data is decrypted using the AES key 314.

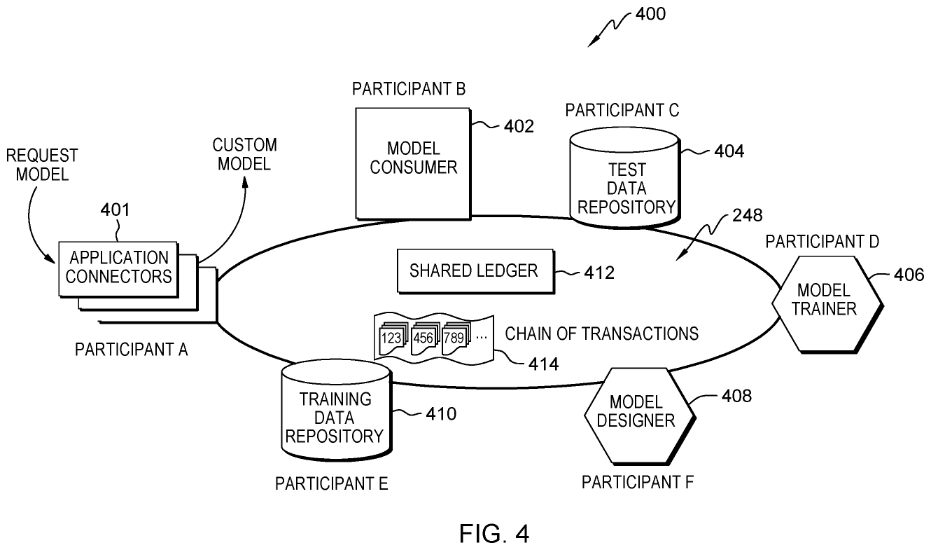

FIG. 4 illustrates a block diagram of an example blockchain network 400, in accordance with example embodiments. Underpinning blockchains are accounting ledgers in a classical sense in that the ledgers (such as shared ledger 412 shown in FIG. 4) allow various participants 402-410 in a blockchain the ability to record transactions, events and activities that are associated with each model. The blockchain ledger 248 serves as the fundamental infrastructure for individual datasets stored in test data repository 404 and/or training data repository 410 to plug into, allowing for data sharing from disparate participants 402-410 and technologies. Individual participants, such as model consumers 402, model trainers 406 and model designers 408 use blockchain ledger technology 248 as a common communication and collaboration channel, thereby allowing each participant 402-410 to post and authenticate information about an activity that requires validation, such as authorizing one's identity in order to utilize training data. This validation is achieved by a consensus algorithm of trust of all parties that see the data. Security of the transaction is achieved by a series of digital, cryptographic public and private “keys” that lock and unlock records for the purpose of controlling data flow and validating authenticity.

This unification allows the blockchain ledger 248 to follow machine learning models in a unique way from model creation to training to efficiency enhancements by recording information as chain of transactions 414 about each model as it evolves over time. For example, in some embodiments, the original data posted to the shared ledger 412 (e.g., model created on March 14) serves as a block record. As model evolves over time, various types of data can be posted to the blockchain ledger 248 as entries in the ledger 412 (e.g., the model was trained by model trainer 406 using a dataset X stored in the test data repository 404 on June 7). These individual entries can then be associated, enriching the data associated with the model and essentially creating a virtual history of the model through its lifecycle. With this information, various participants 402-410 can improve traceability, identify model owners by determining individual contributions/enhancements to the model, and gather auditable documentation on the history of a model. In various embodiments, application connectors 401 may serve as an interface between the blockchain ledger 248 and various model consumers. For example, application connectors 401 may be configured to process model access requests and/or provide generated models to a requester, such as, model dispatcher 230 described above.

In some embodiments, the blockchain network 400 shown in FIG. 4 that is controlled by a model engine (e.g., model engine 210 shown in FIG. 2) may be interconnected with other blockchain networks controlled by other model engines, thusly, forming a model marketplace. Each blockchain network may be associated with a particular domain. This concept of interconnected model engines extends capabilities of each engine by enabling them to share models, machine learning algorithms and even data across different domains. In one embodiment, interaction between various model engines belonging to different domains may be governed by a global smart contract and at least some transactions related to interactions between model engines may be recorded in a global blockchain ledger.

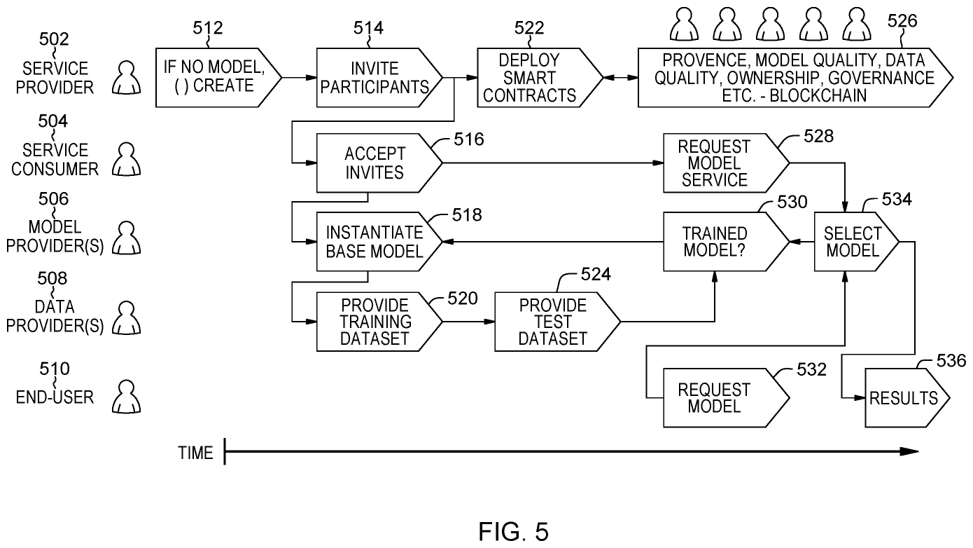

FIG. 5 illustrates a workflow for posting changes to various models as well as changes to training data and testing data to a ledger of the blockchain infrastructure according to an embodiment of the invention. FIG. 5 illustrates a workflow of interaction between various entities associated with the distributed machine learning system. In one embodiment, such entities may include, but are not limited to, one or more blockchain service providers 502, one or more blockchain service consumers 504, one or more machine learning model providers 506, one or more training data and testing data providers 508, one or more distributed machine learning system users 510, and the like.

In one embodiment, the process may be initiated by service providers 502 determining whether one or more machine learning models to be tracked by blockchain infrastructure already exists within the distributed system. If no model exists, service provider 502 may send a request to model provider 506 to create a new model (block 512). Next, service provider 502 may send invitations (block 514) to other participants, such as, for example, service consumers 504 and data providers 508 to join the distributed machine learning system. In response to receiving the invitation from service provider 502, service consumer 504 may accept the invitation (block 516). Model provider 506 may instantiate a base machine learning model (block 518), responsive to receiving the invitation from service provider 502. In one embodiment, model provider 506 may also train the instantiated base machine learning model based on the training dataset provided by one or more data providers 508 (block 520). After sending the invitations to various participants, at block 522, service provider 502 may generate a plurality of smart contracts governing interactions between various participants 504-510, as described above. In addition to providing training dataset, the one or more data providers 508 may also provide one or more testing datasets (block 524) to model provider 506 for model testing purposes.

According to an embodiment of the present invention, in response to receiving model access/service requests 528,532 from either blockchain service consumers 504 or system users 510, respectively, in block 534, model provider 506 may determine whether a trained model satisfying user criteria specified in corresponding request exists. If not, model provider 506 may perform blocks 518, 530 to generate a new model. If a model exists, model provider 506 may render output results to users 510 (block 536). It should be noted, that service provider 502 records a variety of information and metadata related to model provenance, model quality, model data quality, model ownership and other events related to model governance in the blockchain ledger 248 (block 526), as described above.

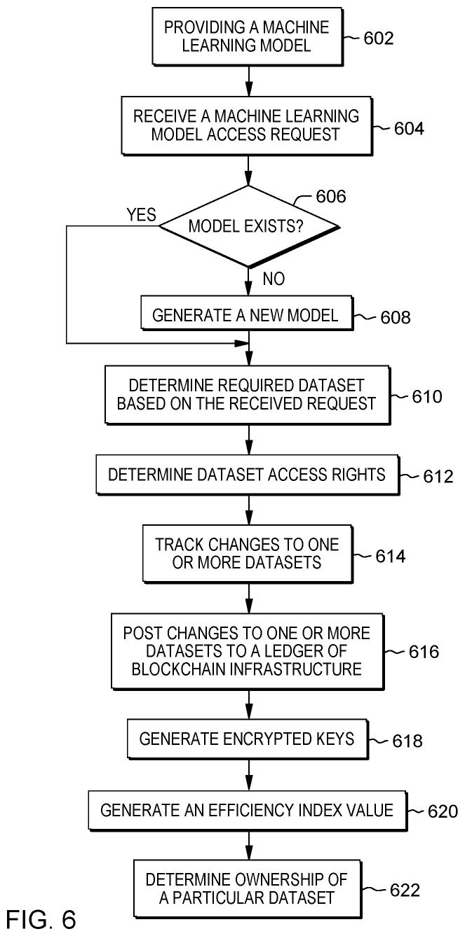

FIG. 6 is a flow diagram of a method for collaboratively producing a machine learning model by two or more entities based on the training data and testing data using blockchain infrastructure, according to some embodiments of the invention. At block 602, model provider 506 provides one or more initial machine learning models to model engine 210. After initialization, at block 604, model dispatcher 230 waits for model access requests and sends them to access controller 204b upon receiving them. In response to receiving a model access request from either model owner/trainer 234 or model consumer 236, access controller 204b authenticates the request and, if the requester is authorized to access model/data of interest, access controller 204b sends the request to model version selector 210. At block 606, model version selector 212 determines if the requested model exists within the distributed system. If not (decision block 606, “No” branch), model engine 210 generates a new model (block 608) in cooperation with model trainer 214 based on corresponding algorithms selected by classifier 218. In response to determining that requested model already exists (decision block 606, “Yes” branch) or during generation of the new model, at block 610, data source selector 202 identifies one or more datasets that are required to satisfy the received request. Prior to performing a corresponding transaction (e.g., updating training data), at block 612, access controller 204a determines if the requester is authorized to perform the transaction based on the retrieved smart contract 246.

According to an embodiment of the present invention, throughout model's lifecycle, model engine 210 may track changes to all data, parameters, participants, owners, and other events. associated with the model. Advantageously, model engine 210 may be further configured to record all changes, events, training/testing data and machine learning algorithms associated with the model as transactions within the shared blockchain ledger (block 616), as described above. In order to complete each transaction, in block 618, at least one of the access controllers 204a, 204b generates an encrypted key that enables the model owner/trainer 234 or model consumer 236 to get access to requested model (or data) without compromising data integrity and data security constraints.

At least in some embodiments, model engine 210, optionally, may be further configured to generate a model efficiency index value (block 620) and/or determine ownership of a particular model or a particular dataset (block 622), as described above.

In summary, various embodiments of the present invention provide a framework that enables creation and sharing of many unique machine learning models in a secure, trustworthy and efficient manner among a plurality of different entities. Such environment encourages each entity to improve models for the benefit of all and/or in order to be rewarded for their contributions. Such rewards may include but are not limited to monetary incentives. Access to various models and/or datasets is controlled by one or more smart contracts which facilitate sharing while also enabling various entities to retain control of various models and/or datasets via a shared blockchain ledger. Such blockchain ledger records, in a distributed fashion, all kinds of information associated with a variety of machine learning models maintained by the system. Some non-limiting examples of information that can be tracked using blockchain mechanism include: data and machine learning algorithms that make up each model, each model's accuracy and consistency measurements, model owners and/or other participants contributing to evolution of the model, and so on.

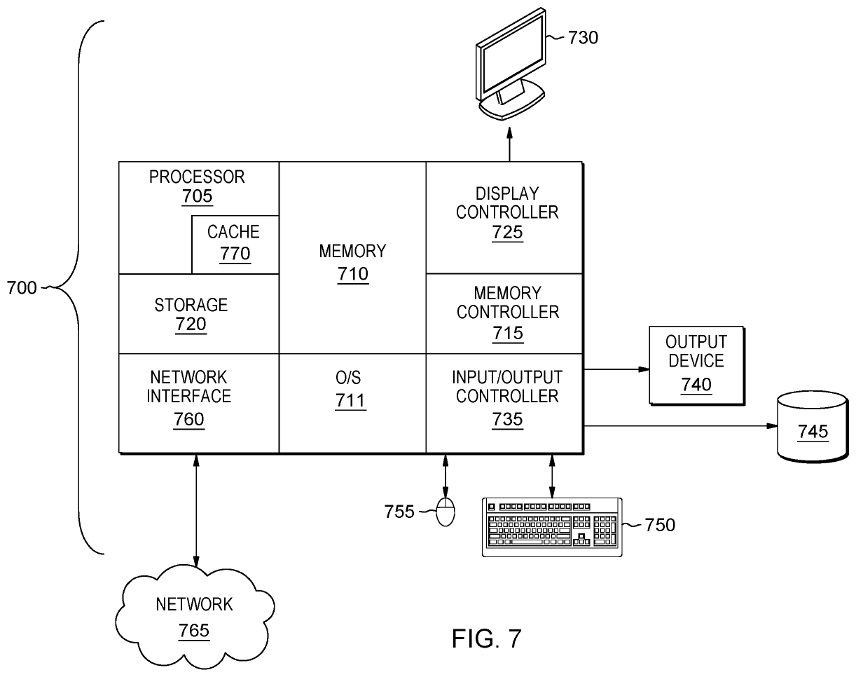

FIG. 7 is a block diagram of a computer system 700 for implementing some or all aspects of the distributed machine learning system 200, according to some embodiments of this invention. The distributed machine learning systems 200 and methods described herein may be implemented in hardware, software (e.g., firmware), or a combination thereof. In some embodiments, the methods described may be implemented, at least in part, in hardware and may be part of the microprocessor of a special or general-purpose computer system 700, such as a personal computer, workstation, minicomputer, or mainframe computer. For instance, the model engine 210, the access controller 204 and the model dispatcher 230 may each be implemented as a computer system 700 or may run on a computer system 700.

In some embodiments, as shown in FIG. 7, the computer system 700 includes a processor 705, memory 710 coupled to a memory controller 715, and one or more input devices 745 and/or output devices 740, such as peripherals, that are communicatively coupled via a local I/O controller 735. These devices 740 and 745 may include, for example, a printer, a scanner, a microphone, and the like. Input devices such as a conventional keyboard 750 and mouse 755 may be coupled to the I/O controller 735. The I/O controller 735 may be, for example, one or more buses or other wired or wireless connections, as are known in the art. The I/O controller 735 may have additional elements, which are omitted for simplicity, such as controllers, buffers (caches), drivers, repeaters, and receivers, to enable communications.

The I/O devices 740, 745 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 705 is a hardware device for executing hardware instructions or software, particularly those stored in memory 710. The processor 705 may be a custom made or commercially available processor, a central processing unit (CPU), an auxiliary processor among several processors associated with the computer system 700, a semiconductor-based microprocessor (in the form of a microchip or chip set), a macroprocessor, or other device for executing instructions. The processor 705 includes a cache 770, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 770 may be organized as a hierarchy of one or more cache levels (L1, L2, etc.).

The memory 710 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, or other types of storage media. Note that the memory 710 may have a distributed architecture, where various components are situated remote from one another but may be accessed by the processor 705.

The instructions in memory 710 may include one or more separate programs, each of which comprises an ordered listing of executable instructions for implementing logical functions. In the example of FIG. 7, the instructions in the memory 710 include a suitable operating system (OS) 711. The operating system 711 essentially may control the execution of other computer programs and provides scheduling, input-output control, file and data management, memory management, and communication control and related services.

Additional data, including, for example, instructions for the processor 705 or other retrievable information, may be stored in storage 720, which may be a storage device such as a hard disk drive or solid-state drive. The stored instructions in memory 710 or in storage 720 may include those enabling the processor to execute one or more aspects of the distributed machine learning system 200 and methods of this disclosure.

The computer system 700 may further include a display controller 725 coupled to a display 730. In some embodiments, the computer system 700 may further include a network interface 760 for coupling to a network 765. The network 765 may be an IP-based network for communication between the computer system 700 and an external server, client and the like via a broadband connection. The network 765 transmits and receives data between the computer system 700 and external systems. In some embodiments, the network 765 may be a managed IP network administered by a service provider. The network 765 may be implemented in a wireless fashion, e.g., using wireless protocols and technologies, such as WiFi, WiMax, etc. The network 765 may also be a packet-switched network such as a local area network, wide area network, metropolitan area network, the Internet, or other similar type of network environment. The network 765 may be a fixed wireless network, a wireless local area network (LAN), a wireless wide area network (WAN) a personal area network (PAN), a virtual private network (VPN), intranet or other suitable network system and may include equipment for receiving and transmitting signals.

Distributed machine learning system 200 and methods according to this disclosure may be embodied, in whole or in part, in computer program products or in computer systems 700, such as that illustrated in FIG. 7.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A distributed machine learning system comprising:
a memory having computer-readable instructions;
one or more processors for executing a model engine communicatively coupled to at least one data source storing training data and at least one data source storing testing data, wherein the model engine is being operated in accordance with a smart contract to enable two or more entities to collaboratively produce a machine learning model based on the training data using blockchain infrastructure, wherein contributions of each of the two or more entities are entered into a ledger of the blockchain infrastructure as blocks and wherein the model engine is configured to execute the computer-readable instructions, the computer-readable instructions comprising:
providing a machine learning model that utilizes the training data and testing data based on criteria specified by the two or more entities;
tracking changes to the machine learning model, training data or testing data made by at least one of the two or more entities;
posting changes to the machine learning model, training data or testing data to the ledger of the blockchain infrastructure according to terms and specifications of the smart contract; and
generating encrypted keys to enable the two or more entities to utilize the blockchain infrastructure to exchange the tracked changes to the machine learning model, training data or testing data and to exchange an updated machine learning model.

2. The distributed machine learning system of claim 1, wherein data access rights to a particular data set of the training data or testing data are determined by a predefined agreement specified by the smart contract.

3. The distributed machine learning system of claim 2, further comprising one or more processors for executing a data selector module, wherein the data selector module is configured to execute the computer-readable instructions comprising determining the particular data set required for the provided machine learning model.

4. The distributed machine learning system of claim 2, wherein the computer-readable instructions further comprise generating an efficiency index value indicative of accuracy of the provided machine learning model.

5. The distributed machine learning system of claim 1, wherein providing the machine learning model further comprises determining whether a machine learning model requested by the one of the two or more entities exists within the distributed machine learning system and generating a new machine learning model that utilizes the blockchain ledger, responsive to a determination that the requested machine learning model does not exist within the distributed machine learning system.

6. The distributed machine learning system of claim 1, further comprising one or more processors for executing a plurality of model engines communicatively coupled to each other and configured to exchange respective machine learning models using an integrated blockchain infrastructure.

7. The distributed machine learning system of claim 4, wherein the computer-readable instructions further comprise determining ownership of a particular machine learning model or the particular data set based on respective contributions by at least one of the two or more entities to the particular machine learning model or to the particular data set.

8. The distributed machine learning system of claim 7, wherein degree of shared ownership of the particular machine learning model is determined based on ownership of a training data set or a testing data set associated with the particular machine learning model, based on ownership of machine learning algorithm associated with the particular machine learning model and based on how the training data set, testing data set and the machine learning algorithm associated with the particular machine learning model contribute to the generated efficiency index value.

9. A method for enabling two or more entities to collaboratively produce a machine learning model based on training data using blockchain infrastructure in a distributed machine learning system, the method comprising:
providing a machine learning model that utilizes the training data and testing data based on criteria specified by two or more entities;
tracking changes to the machine learning model, training data or testing data made by at least one of the two or more entities;
posting changes to the machine learning model, training data or testing data to a ledger of the blockchain infrastructure according to terms and specifications of a smart contract, wherein the smart contract enables the two or more entities to collaboratively produce the machine learning model based on the training data using the blockchain infrastructure, and wherein contributions of each of the two or more entities are entered into the ledger of the blockchain infrastructure as blocks; and
generating encrypted keys to enable the two or more entities to utilize the blockchain infrastructure to exchange the tracked changes to the machine learning model, training data or testing data and to exchange an updated machine learning model.

10. The method of claim 9, wherein data access rights to a particular data set of the training data or testing data are determined by a predefined agreement specified by the smart contract.

11. The method of claim 10, the method further comprising determining the particular data set required for the provided machine learning model.

12. The method of claim 10, the method further comprising generating an efficiency index value indicative of accuracy of the provided machine learning model.

13. The method of claim 9, wherein providing the machine learning model further comprises determining whether a machine learning model requested by the one of the two or more model consuming entities exists within the distributed machine learning system and generating a new machine learning model that utilizes the blockchain ledger, responsive to a determination that the requested machine learning model does not exist within the distributed machine learning system.

14. The method of claim 9, executing a plurality of model engines communicatively coupled to each other and configured to exchange respective machine learning models using an integrated blockchain infrastructure.

15. The method of claim 12, the method further comprising determining ownership of a particular machine learning model or the particular data set based on respective contributions of the entities to the particular machine learning model or to the particular data set.

16. The method of claim 15, wherein degree of shared ownership of the particular machine learning model is determined based on ownership of a training data set or a testing data set associated with the particular machine learning model, based on ownership of machine learning algorithm associated with the particular machine learning model and based on how the training data set, testing data set and the machine learning algorithm associated with the particular machine learning model contribute to the generated efficiency index value.

17. A computer-program product for enabling two or more entities to collaboratively produce a machine learning model based on training data using blockchain infrastructure in a distributed machine learning system, the computer-program product comprising a computer-readable storage medium having program instructions embodied therewith, the program instructions executable by a processor to cause the processor to perform a method comprising:
providing a machine learning model that utilizes the training data and testing data based on criteria specified by two or more entities;
tracking changes to the machine learning model, training data or testing data made by at least one of the two or more entities;
posting changes to the machine learning model, training data or testing data to a ledger of the blockchain infrastructure according to terms and specifications of a smart contract, wherein the smart contract enables the two or more entities to collaboratively produce the machine learning model based on the training data using the blockchain infrastructure, and wherein contributions of each of the two or more entities are entered into the ledger of the blockchain infrastructure as blocks; and
generating encrypted keys to enable the two or more entities to utilize the blockchain infrastructure to exchange the tracked changes to the machine learning model, training data or testing data and to exchange an updated machine learning model.

18. The computer-program product of claim 17, wherein data access rights to a particular data set of the training data or testing data are determined by a predefined agreement specified by the smart contract.

19. The computer-program product of claim 18, the method further comprising determining the particular data set required for the provided machine learning model.

20. The computer-program product of claim 18, the method further comprising generating an efficiency index value indicative of accuracy of the provided machine learning model.
